(19) United States
(12) Patent Application Publication
(10) Pub. No.: US 2025/0172471 A1
(43) Pub. Date: May 29, 2025

(54) CONVERTIBLE DEVICE FOR TESTING BOND BETWEEN NEAR-SURFACE MOUNTED COMPOSITES AND MEDIA

(71) Applicant: KING FAHD UNIVERSITY OF PETROLEUM AND MINERALS, Dhahran (SA)

(72) Inventor: Faisal MUKHTAR, Dhahran (SA)

(73) Assignee: KING FAHD UNIVERSITY OF PETROLEUM AND MINERALS, Dhahran (SA)

(21) Appl. No.: 18/520,754

(22) Filed: Nov. 28, 2023

(51) Int. Cl. G01N 3/24; B32B 43/00; G01N 3/04

(52) U.S. Cl. CPC G01N 3/24; B32B 43/006; G01N 3/04; B32B 2305/08; B32B 2307/748; B32B 2315/06

(57) ABSTRACT

A debonding test apparatus includes a structural block having a receiving space formed therein; a pair of clamps; an adjustable hanger; and an attachment mechanism. The structural block includes a top surface, a first lateral surface, a second lateral surface, a bottom surface, and a structural body. The structural body extends from the top surface to the bottom surface between the first lateral surface and the second lateral surface. The receiving space traverses through the structural body between the first lateral surface and the second lateral surface adjacent the bottom surface of the structural block. The adjustable hanger is slidably positioned into the receiving space adjacent a top end of the receiving space. The pair of clamps is slidably coupled to the adjustable hanger. The structural block, the pair of clamps, and the adjustable hanger are detachably attached to each other through the attachment mechanism.

### STATEMENT REGARDING PRIOR DISCLOSURE BY THE INVENTORS

Aspects of the present disclosure are related to applicant's No. U.S. Pat. No. 11,169,082 B2 titled “Universal Debonding Test Apparatus for Carbon Fiber Reinforced Polymer-Concrete System and Method for Sequential Multi-Testing”, which is incorporated herein by reference in its entirety.

### BACKGROUND

### Technical Field

The present disclosure is directed to evaluation and testing methodologies and apparatuses for examining the bond strength between fiber-reinforced polymer (FRP) materials, such as bars, strips, or sheets, and structural concrete elements. In particular, the present disclosure provides a debonding test apparatus designed to address and enhance the capabilities of traditional bond testing methods, specifically for near surface mounting (NSM) techniques.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The characteristics of advanced composites such as eco-friendly, lightweight, corrosion-free, and thermally efficient make fiber-reinforced polymer (FRP) sheets, rods, or strips among the best recognized materials for concrete infrastructural rehabilitation and/or strengthening against flexure, shear, torsion, and/or compression. The two most prevalent strengthening approaches are externally bonded reinforcement (EBR) in the form of sheets and near surface mounting (NSM) in the form of bars/strips. Each of these techniques relies on a proper bond between the strengthening material and the structural substrate for load transfer and an increase in the structural member's capacity. The NSM requires inserting FRP reinforcing bars into grooves that have been pre-formed in the concrete members and embedding them with a high-strength adhesive, as opposed to the EBR, which involves bonding a laminate or textile onto the surface of the concrete element. The main advantages of NSM over EBR include decreased probability to premature debonding with more effective utilization of the reinforcing material, convenience of adding reinforcement to adjoining structural elements, less preparation work, increased FRP protection against external harmful elements, and reduced aesthetical visibility.

Given that the excellent mechanical features of FRP need to be efficiently transferred to the structural elements being strengthened via the interfacial zone between the member and the FRP, the integrity of their connections becomes an important decision variable for design in bonding applications. In other words, their design is premised on full reliance on load transfer from the substrate to the FRP system through the bond at the interface. To achieve that, however, a clear understanding of the different modes of bond stress transfer and degradation is a pre-requisite. Debonding of FRP typically starts before the tensile strength of the FRP reinforcement is attained.

Many attempts focused on the topic of NSM bonds utilizing various test methodologies seeking to simulate the NSM FRP system's pull-out strength commonly encountered during the life of the strengthened structural members. There exist several test methods for evaluating the bond performance prior to the design and deployment of such strengthening systems to in situ applications. In particular, various forms of pull-out tests have been designed. The beam bending, double shear, and single shear tests are the bond test classifications that are most frequently used to examine the bond between NSM FRP, adhesive, and concrete.

FIGS. 1A-1J illustrate different variations in test setups for evaluating the bond between NSM FRP with structural media (e.g., concrete). Specifically, FIG. 1A and FIG. 1B illustrate a concrete block 10A having an embedded NSM bar 12A using an adhesive 14A undergoing a single shear test when subjected to opposing forces ‘P’. FIG. 1C and FIG. 1D illustrate two adjacent concrete blocks 10C having a pair of embedded NSM bars 12C using adhesives 14C undergoing a symmetric double shear test when subjected to opposing forces ‘P’ provided at steel rebars 16C. FIG. 1E and FIG. 1F illustrate a concrete block 10E having an embedded NSM bar 12E using an adhesive 14E at a non-symmetric offset ‘O’ undergoing a single shear test for edge effect assessment when subjected to opposing forces ‘P’. FIG. 1G and FIG. 1H illustrate two adjacent concrete blocks 10G having a pair of embedded NSM bars 12G using adhesives 14G undergoing a non-symmetric double shear test when subjected to opposing forces ‘P’ provided at steel rebars 16G. FIG. 1I and FIG. 1J illustrate two adjacent concrete blocks 10I connected by a hinge 18 and having an embedded NSM bar 12I using an adhesive 14I extending therebetween, undergoing a beam bending test when subjected to a loading force ‘P’.

It may be noted that while prismatic blocks are commonly used in single and double shear tests, the beam bending test requires a block with an initial notch in the middle or two concrete blocks joined by a mechanical hinge, adopting the configuration for three- or four-point bending tests. As can be seen from FIGS. 1A-1J, variants of the single and double shear bond tests also exist. For example, when the concrete edge distance is less than a threshold value, which is mostly based on the groove height and the concrete strength, the edge distance can have a substantial impact on NSM FRP bonding. Hence, the configuration shown in FIGS. 1E and 1F becomes handy for such an assessment. Basically, a higher threshold value of edge distance results from a larger groove height or concrete strength. NSM bond tests require an adequate edge distance to avoid its negative impact on bond strength. The non-symmetric double shear bond test (FIGS. 1G and 1H) is also useful in studying the effect and interaction between more than one NSM bar, which is more likely to be the case in practice than the use of single embedded bar.

When bond tests using NSM FRP strips/bars are conducted, multiple failure types can be seen, such as failure through debonding at the adhesive-FRP interface, cohesive failure in the adhesive, failure at the adhesive-concrete interface, cohesive failure in the concrete, and FRP ruptures. Experimental and numerical evidence for the effectiveness of NSM bond test methods shows that single shear and double shear tests are preferred for characterizing the relevant bond data required for the formulations related to the modeling of the influence of NSM FRP bars to the shear strengthening of reinforced concrete (RC) beams. On the other hand, the beam bending bond test is more convenient for the characterization of the relevant bond data required for the formulae used to predict the contribution of NSM-FRP bars to the flexural strengthening of RC beams/slabs.

Given the existence of other forms of strengthening systems, such as the wet layup FRP sheets, pultruded FRP laminates, fiber-reinforced cementitious mortar (FRCM), shape memory alloy (SMA) plates or bars/strips, etc., proper selection of the composite material for structural strengthening requires their relative assessments. Traditionally, different purpose-built test setups are used (sometimes on an ad hoc basis) whenever an NSM FRP bond test assessment is required, the results of which are used to provide conclusions that may be subjective to a specified test scale.

CN109490096A discloses a bending crack resistance testing device including a pair of clamping mechanisms for clamping a test piece. Herein, clamping device is used for clamping test pieces.

CN114659978A discloses a fiber-drawing device including an auxiliary clamp and a base clamp. The sample is placed between a fixed block and a movable block which is movable on a base plate due to grooves and a push rod.

CN115753352A discloses a shear strength test fixture including a base, two base pad mechanisms, a fixed lower indenter, a fixed upper indenter, a press head, a pin and a test piece. The base pad mechanisms include threaded holes and fastening bolts. The press head includes a press block, a clamping hole and a clamping groove while the test piece is set in the clamping groove.

U.S. Pat. No. 8,322,227B2 discloses a tension testing device including a base, a hanger and a clamp. Meanwhile, in an alternative version, the hanger may arguably be an adjustable hanger having receiving slots that perpendicularly traverse through the first arm portion and the second arm portion. However, the pin only penetrates a seating portion of the hanger. Note that the pin is part of an electronic element so the pin does not penetrate of the hanger. Nor does the pin penetrate through the clamp. Moreover, the hanger is not slidable.

Each of the aforementioned references suffers from one or more drawbacks hindering their adoption. None of the references above describes a bonding test device that is convertible and capable of performing various bonding tests under different conditions.

Based on the above, there exists no single apparatus that can fit in all the major composite systems for infrastructural strengthening. Therefore, there is still a need for unifying test methods for every NSM bond test to possess comparable NSM bond test results between research laboratories. Accordingly, it is one object of the present disclosure to provide a debonding test apparatus that not only ensures precise and reliable results but also offers flexibility to cater to a broad spectrum of materials and testing conditions.

### SUMMARY

In an exemplary embodiment, a debonding test apparatus is disclosed. The debonding test apparatus includes a structural block having a receiving space formed therein; a pair of clamps; an adjustable hanger; and an attachment mechanism. Herein, the structural block includes a top surface, a first lateral surface, a second lateral surface, a bottom surface, and a structural body. Also, the structural body extends from the top surface to the bottom surface between the first lateral surface and the second lateral surface. Further, the receiving space traverses through the structural body of the structural block between the first lateral surface and the second lateral surface adjacent the bottom surface of the structural block. Further, the adjustable hanger is slidably positioned into the receiving space adjacent a top end of the receiving space. Furthermore, the pair of clamps is slidably coupled to the adjustable hanger. Moreover, the structural block, the pair of clamps, and the adjustable hanger are detachably attached to each other through the attachment mechanism.

In some embodiments, the adjustable hanger includes a middle block, a first arm portion, a second arm portion, and a plurality of receiving slots formed in the adjustable hanger. The middle block is positioned between the first arm portion and the second arm portion. The plurality of receiving slots perpendicularly traverses through the first arm portion and the second arm portion.

In some embodiments, the pair of clamps includes a first clamp having a first top portion that is positioned between the first arm portion and the second arm portion. The first top portion is concentrically aligned with a first receiving slot of the plurality of receiving slots. The first top portion is hollow.

In some embodiments, the debonding test apparatus further includes a first pin. The first pin is concentrically aligned with the first receiving slot. The first pin is slidably positioned through a first portion of the first receiving slot traversing the first arm portion, the first top portion of the first clamp, and a second portion of the first receiving slot traversing the second arm portion.

In some embodiments, the pair of clamps includes a second clamp having a second top portion that is positioned between the first arm portion and the second arm portion. The second top portion is concentrically aligned with a second receiving slot of the plurality of receiving slots. The second top portion is hollow.

In some embodiments, the debonding test apparatus further includes a second pin. The second pin is concentrically aligned with the second receiving slot. The second pin is slidably positioned through a first portion of the second receiving slot traversing the first arm portion, the second top portion of the second clamp, and a second portion of the second receiving slot traversing the second arm portion.

In some embodiments, the debonding test apparatus further includes a plurality of circlips configured to mechanically secure the first pin and the second pin.

In some embodiments, the plurality of circlips includes a first circlip positioned at the first portion of the first receiving slot; a second circlip positioned at the second portion of the first receiving slot; a third circlip positioned at the first portion of the second receiving slot; and a fourth circlip positioned at the second portion of the second receiving slot.

In some embodiments, the pair of clamps includes a first clamp. The first clamp incudes a first clamp block; a second clamp block; a plurality of bolt slots that perpendicularly traverses through the first clamp block and the second clamp block; and a plurality of block-fastening bolts that traverse through the plurality of bolt slots, are engageable with fastening washers or nuts, and are configured to fasten the first clamp block and the second clamp block.

In some embodiments, the first clamp block includes a first T-shaped portion. The second clamp block includes a second T-shaped portion that is aligned with the first T-shaped portion when fastened.

In some embodiments, the first clamp block includes a first top section above the first T-shaped portion. The second clamp block includes a second top section above the second T-shaped portion. A pin slot traverses through the first top section and the second top section, which forms the first top portion of the first clamp which is hollow.

In some embodiments, the middle block is positioned between the first receiving slot and the second receiving slot.

In some embodiments, the first receiving slot and the second receiving slot have an equal distance from the middle block.

In some embodiments, the debonding test apparatus further includes an attachment plate having a plurality of bolt slots. A plurality of plate-fastening bolts that traverse through the plurality of bolt slots and are configured to fasten the attachment plate to the first lateral surface of the structural block.

In some embodiments, the debonding test apparatus further includes a threaded gripping rod threadedly engageable with a receiving channel traversing through the top surface of the structural block

In some embodiments, the debonding test apparatus further includes a realignment coupler between the top surface of the structural block and the threaded gripping rod when the threaded gripping rod is engaged.

In some embodiments, the debonding test apparatus further includes a coupling hinge having grooves and engageable with one of the pair of clamps via a groove pin.

In some embodiments, the debonding test apparatus further includes a pair of bolts configured to attach the coupling hinge to a concrete block.

In some embodiments, the pair of clamps includes a first clamp having a top section, a middle section below the top section and a bottom section below the middle section. The middle section and the top section form a first T shape. The middle section and the bottom section form a second T shape.

In some embodiments, the second T shape is oriented upside down relative to the first T shape.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a diagrammatic perspective view illustration of a traditional set-up for single shear testing;

FIG. 1B is a diagrammatic planar view illustration of the traditional set-up for single shear testing of FIG. 1A;

FIG. 1C is a diagrammatic perspective view illustration of a traditional set-up for symmetric double shear testing;

FIG. 1D is a diagrammatic planar view illustration of the traditional set-up for symmetric double shear testing of FIG. 1C;

FIG. 1E is a diagrammatic perspective view illustration of a traditional set-up for single shear testing for edge effect assessment;

FIG. 1F is a diagrammatic planar view illustration of the traditional set-up for single shear testing for edge effect assessment of FIG. 1E;

FIG. 1G is a diagrammatic perspective view illustration of a traditional set-up for non-symmetric double shear testing;

FIG. 1H is a diagrammatic planar view illustration of the traditional set-up for non-symmetric double shear testing of FIG. 1G;

FIG. 1I is a diagrammatic perspective view illustration of a traditional set-up for beam bending testing;

FIG. 1J is a diagrammatic planar view illustration of the traditional set-up for beam bending testing of FIG. 1I;

FIG. 2A is a simplified illustration of implementation of a test specimen's configuration for a modified double-lap shear test, as only applicable to U-shape dry fibers for wet layup FRP;

FIG. 2B is a diagrammatic illustration of implementation of a debonding test apparatus for double-lap shear test, as only applicable to U-shape dry fibers for wet layup FRP;

FIG. 3A is a simplified illustration of implementation of a test specimen's configuration for a mixed-mode test, as only applicable to U-shape dry fibers for wet layup FRP;

FIG. 3B is a diagrammatic illustration of implementation of a debonding test apparatus for mixed-mode test, as only applicable to U-shape dry fibers for wet layup FRP;

FIG. 4 is a diagrammatic illustration of implementation of a debonding test apparatus of for adaptability to variable specimen sizes during double-lap shear test, as only applicable to U-shape dry fibers for wet layup FRP;

FIG. 5 is a diagrammatic illustration of a hanger as utilized in debonding test apparatus;

FIG. 6A is a diagrammatic assembled view illustration of a debonding test apparatus, according to a first embodiment;

FIG. 6B is a diagrammatic disassembled view illustration of the debonding test apparatus of FIG. 6A, according to the first embodiment;

FIG. 6C is a diagrammatic exploded view illustration of the debonding test apparatus of FIG. 6A, according to the first embodiment;

FIG. 7A is an illustration of the debonding test apparatus of FIG. 6A being set-up for a single shear pull-out test, according to the first embodiment;

FIG. 7B is an illustration of the debonding test apparatus of FIG. 6A being implemented for a single shear pull-out test, according to the first embodiment;

FIG. 7C is an illustration of the debonding test apparatus of FIG. 6A being set-up for studying an edge distance effect in a single shear pull-out test, according to the first embodiment;

FIG. 7D is an illustration of the debonding test apparatus of FIG. 6A being implemented for studying an edge distance effect in a single shear pull-out test, according to the first embodiment;

FIG. 7E is an illustration of the debonding test apparatus of FIG. 6A being set-up for a symmetric double shear pull-out test, according to the first embodiment;

FIG. 7F is an illustration of the debonding test apparatus of FIG. 6A being implemented for a symmetric double shear pull-out test, according to the first embodiment;

FIG. 7G is an illustration of the debonding test apparatus of FIG. 6A being set-up for an asymmetric double shear pull-out test, according to the first embodiment;

FIG. 7H is an illustration of the debonding test apparatus of FIG. 6A being implemented for an asymmetric double shear pull-out test, according to the first embodiment;

FIG. 7I is an illustration of the debonding test apparatus of FIG. 6A being set-up for a beam bending test, according to the first embodiment;

FIG. 7J is an illustration of the debonding test apparatus of FIG. 6A being implemented for a beam bending test, according to the first embodiment;

FIG. 8A is a diagrammatic assembled view illustration of a debonding test apparatus, according to a second embodiment;

FIG. 8B is a diagrammatic exploded view illustration of the debonding test apparatus of FIG. 8A, according to the second embodiment;

FIG. 9A is a simplified illustration of a test specimen's configuration for a modified double-lap shear test, according to certain embodiments;

FIG. 9B is a diagrammatic illustration of a test specimen's configuration for a modified double-lap shear test, according to certain embodiments;

FIG. 9C is a diagrammatic illustration of a modified form of the debonding test apparatus of FIG. 8A being implemented for a double-lap shear test using a pair of side plates, according to certain embodiments;

FIG. 10A is a simplified illustration of a modified form of a test specimen's configuration suitable for use with the debonding test apparatus of the debonding test apparatus of FIG. 8A being implemented for a mixed-mode test, according to certain embodiments;

FIG. 10B is a diagrammatic illustration of a modified form of the debonding test apparatus of FIG. 8A being implemented for a mixed-mode test, according to certain embodiments; and

FIG. 11 is a diagrammatic illustration of a modified form of the debonding test apparatus of FIG. 8A being implemented for adaptability to variable specimen sizes during the double-lap shear test, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

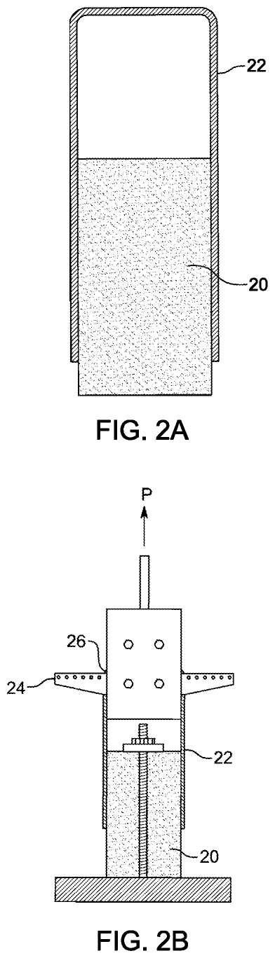

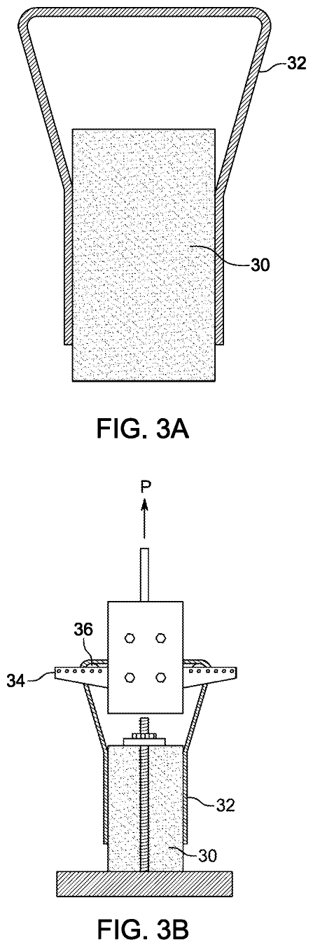

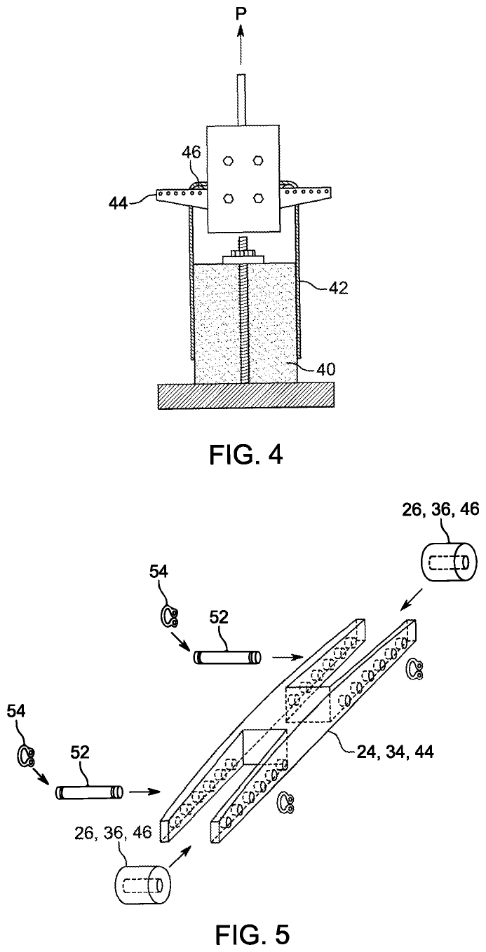

With no existing bond test apparatus capable of conducting all the bond test types for the EBR system, the issue was addressed by developing the apparatus described in a U.S. Pat. No. 11,169,082B2 titled “Universal Debonding Test Apparatus for Carbon Fiber Reinforced Polymer-Concrete System and Method for Sequential Multi-Testing,” as incorporated herein by reference in its entirety. Despite being convertible to different bond test methods for EBR systems, some aspects of the debonding test apparatus of U.S. Pat. No. 11,169,082B2 were designed with the wet layup FRP type in mind. Specifically, as illustrated in FIGS. 2A-2B, 3A-3B, 4 and 5, the double-lap shear test (FIGS. 2A and 2B), the mixed-mode test (FIGS. 3A and 3B), or the double-lap shear with variable specimen size test (FIG. 4) for a concrete specimen 20, 30 or 40 by the debonding test apparatus of U.S. Pat. No. 11,169,082B2 require the use of U-shape FRP 22 or 42 in the case of the double-lap shear test (FIG. 2B or FIG. 4), or the wrapped FRP 32 in the case of the mixed-mode test (FIG. 3B), which may only be attained using the wet layup system by avoiding saturating the U-shape portion with the epoxy adhesive. Also, as shown in FIGS. 2B, 3B and 4, the debonding test apparatus of U.S. Pat. No. 11,169,082B2 uses a pair of rollers 26, 36, and 46 coupled with a hanger 24, 34, and 44. Further, as shown in FIG. 5, the debonding test apparatus of U.S. Pat. No. 11,169,082B2 employs the pair of rollers 26, 36, and 46 coupled with the hanger 24, 34, and 44 using a pair of pins 52 and a pair of circlips 54. Herein, the U-shape FRP 22 and 42 of FIGS. 2A-2B and FIG. 4, or the wrapped FRP 32 of FIGS. 3A-3B pass before subjecting the setup to a tensile load ‘P’ until the interfacial debonding between the concrete specimen 20, 30, and 40 and the FRP 22, 32, and 42. Given that some EBR strengthening systems, for example, the pultruded FRP laminate, are unbendable, this limits the debonding test apparatus of U.S. Pat. No. 11,169,082B2 for application to the pultruded FRP laminates, or their kinds, during the double-lap shear and mixed-mode tests. Even in the case of application to wet layup FRP system, the use of U-shape unsaturated dry fibers suffers from the tendency of the dry fiber rupture due to stress concentrations between the fibers and the rollers over which they passed in the debonding test apparatus of U.S. Pat. No. 11,169,082B2.

Aspects of the present disclosure are directed to a debonding test apparatus designed to efficiently and accurately assess the adhesive bond strength between materials. The debonding test apparatus of the present disclosure resolves the identified limitations of the debonding test apparatus of U.S. Pat. No. 11,169,082 B2. The debonding test apparatus provides a convertible test apparatus as an extension of the debonding test apparatus of U.S. Pat. No. 11,169,082B2 to make it applicable to conduct all the test types of the bond between NSM FRP and structural media, such as concrete. The limitation of the debonding test apparatus of U.S. Pat. No. 11,169,082 B2 as applicable to only the use of wet layup FRP using the foldable dry fibers is also addressed by designing a new clamping system capable of testing unbendable pultruded FRP laminates. Further, even in the case of a wet layup system, the present debonding test apparatus eliminates the tendency of fiber rupture by allowing the casting of the test specimen with straight/disconnected FRP sheets rather than the U-shape dry fibers that suffer from the tendency of rupture due to stress concentration.

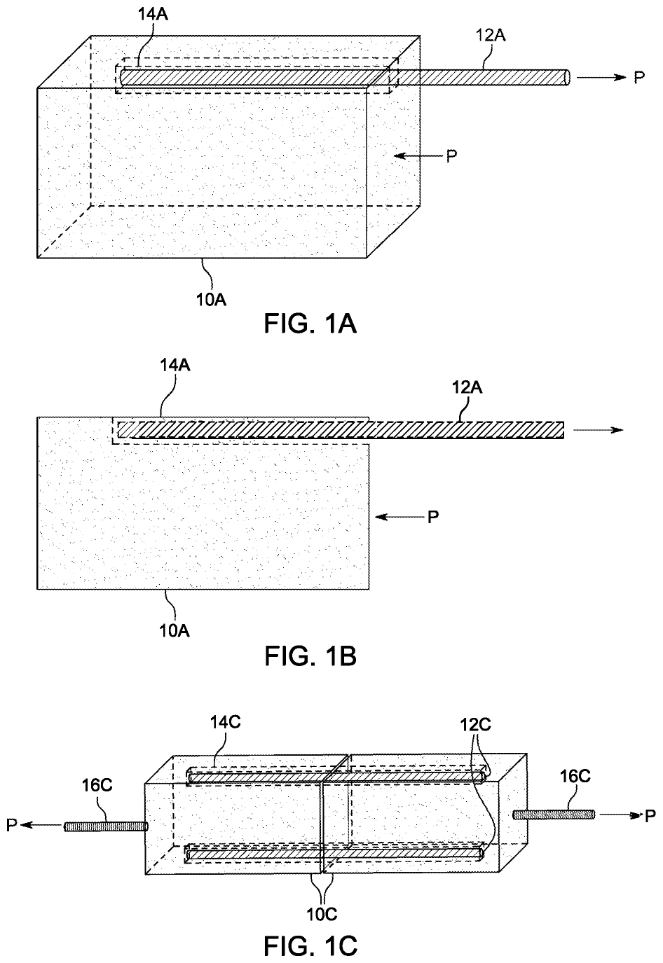

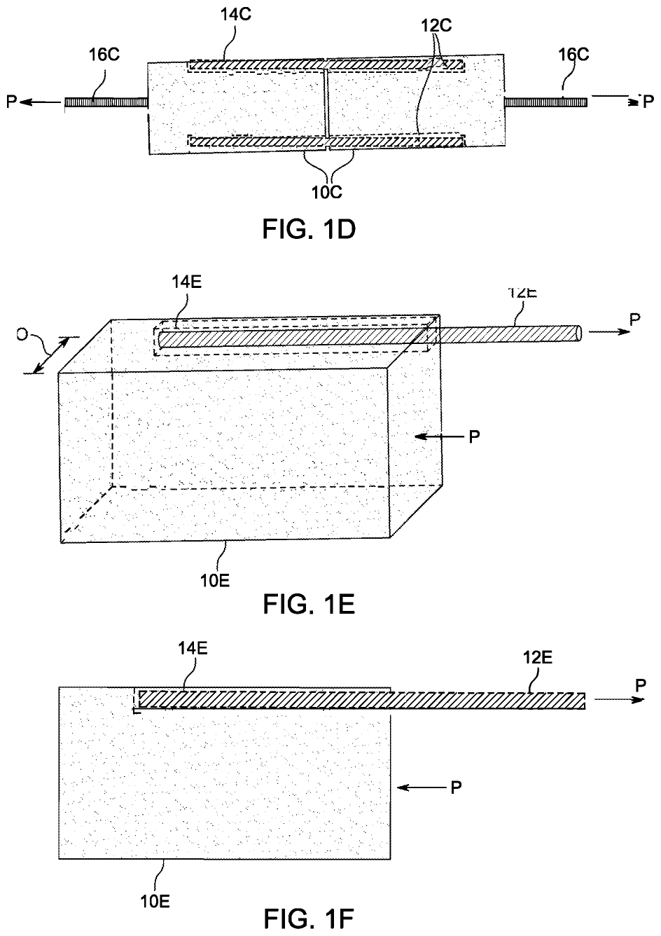

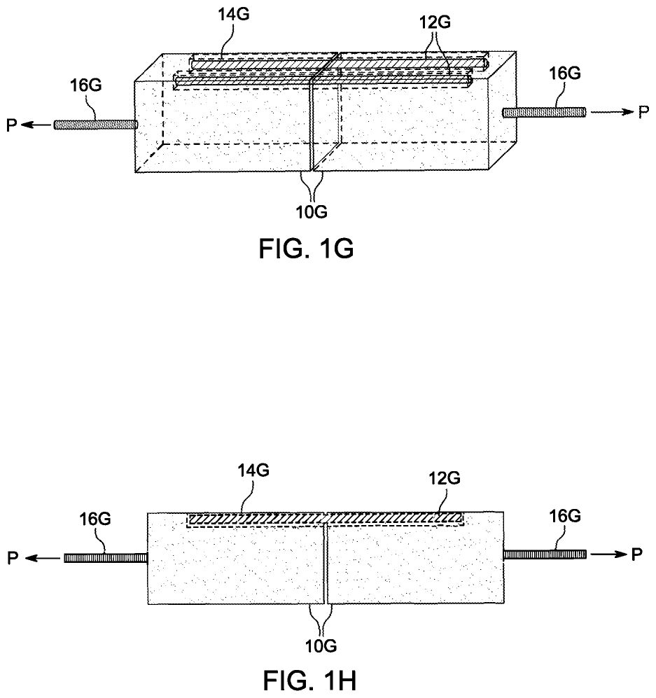

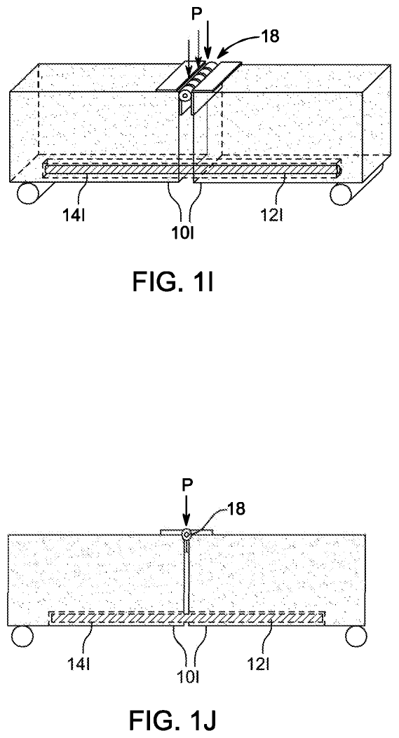

Therefore, the debonding test apparatus of the present disclosure is applicable to all NSM bond tests. Since there is no unanimous standard bond test method for NSM FRP, this would allow test laboratories to use any of their preferred method of testing (as described in reference to FIGS. 1A-1J) using the present debonding test apparatus. Moreover, for most of the tests, the present debonding test apparatus reduces the required specimen size by half, thereby resulting in a more economical testing technique compared to the traditional ones.

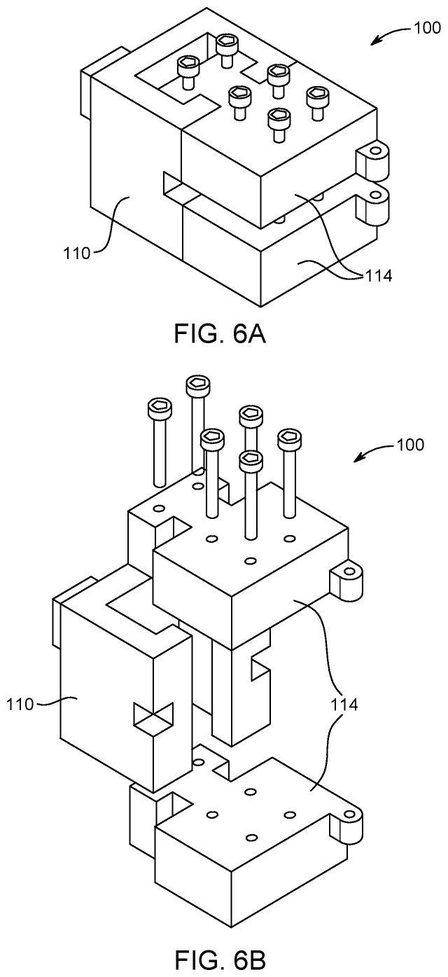

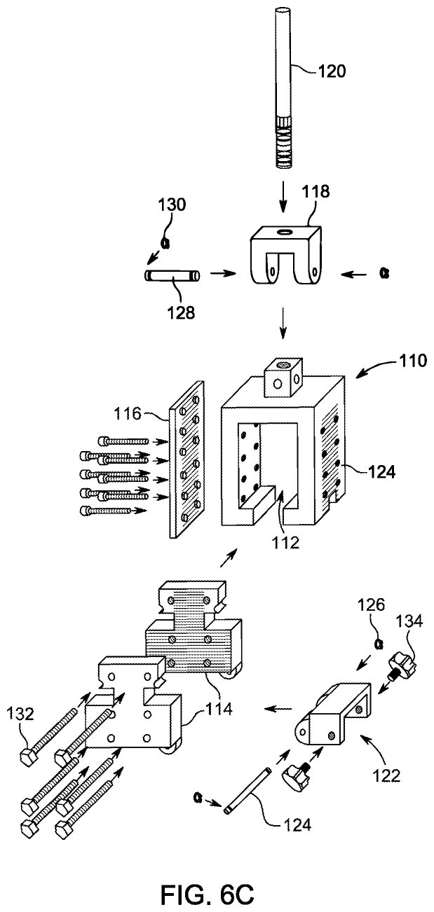

Referring to FIGS. 6A-6C, in combination, illustrated are different views of a debonding test apparatus (generally designated by reference numeral 100), according to a first embodiment of the present disclosure. Herein, FIG. 6C provides a disassembled, exploded view of the debonding test apparatus 100. The debonding test apparatus 100 with some accessories attached and assembled, are shown in FIGS. 6A and 6B in different possible configurations depending on the user's choice of which bond test type to be conducted. A user has a choice to select which of the tests they desire to perform by choosing the appropriate combination of the accessories.

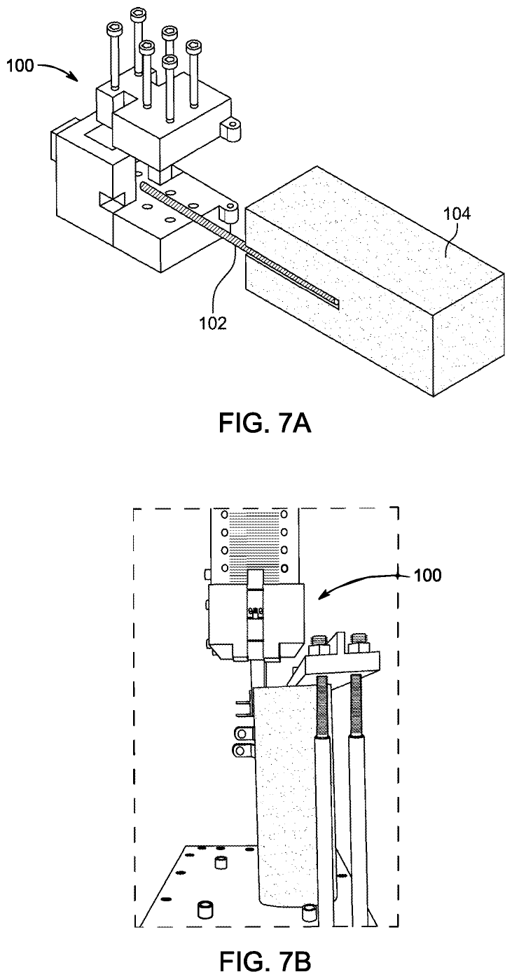

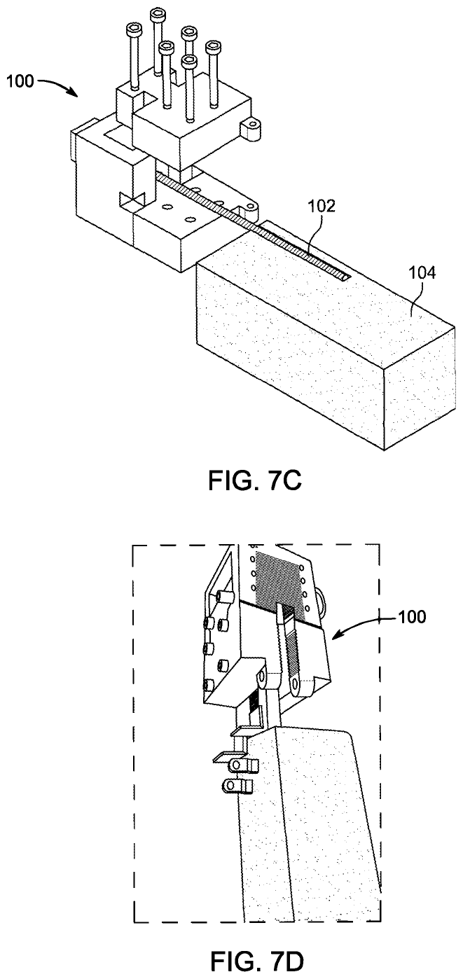

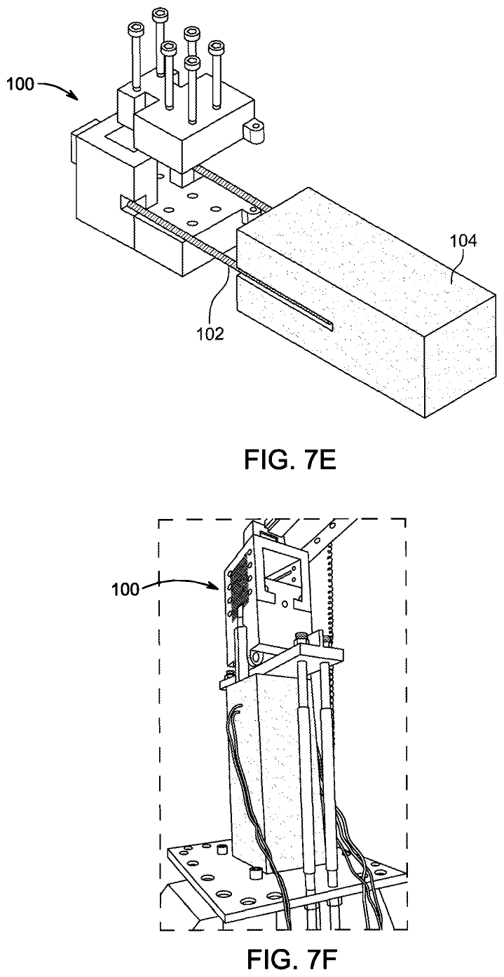

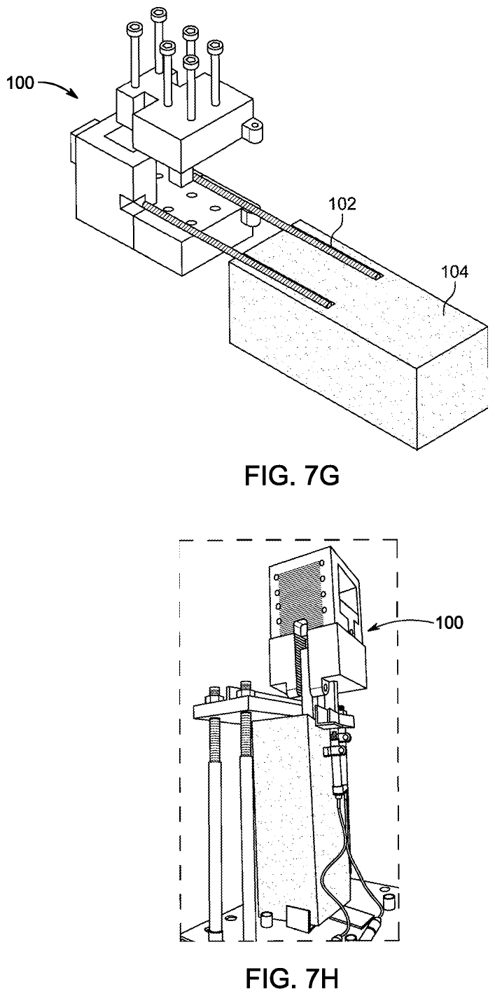

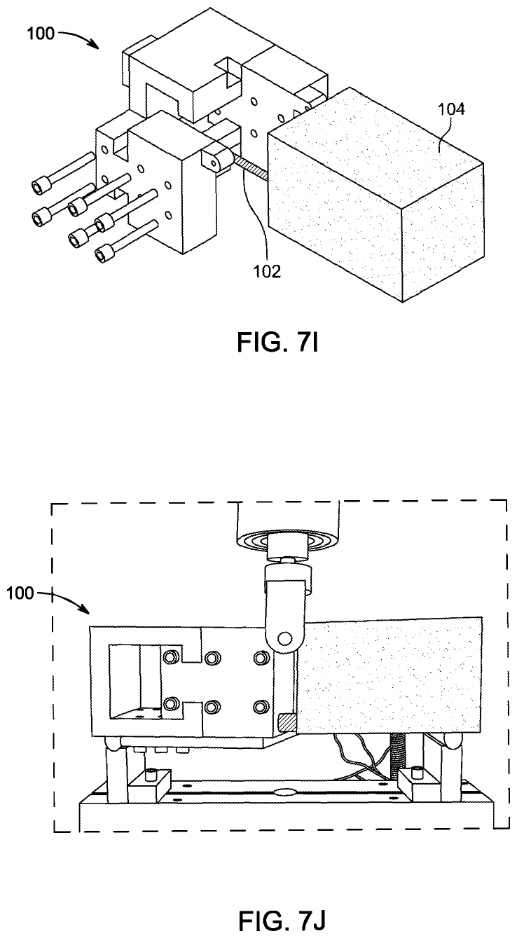

The debonding test apparatus 100 includes a structural block 110 having a receiving space 112 formed therein. The structural block 110 is provided with multiple accessories, including a pair of clamps 114, a side plate 116, and a coupler 118 to which a threaded gripping rod 120 can be attached. These accessories allow the structural block 110 to be used for conducting NSM FRP-concrete bond tests between NSM FRP 102 and concrete block 104 (as shown in FIGS. 7A-7J). The pair of clamps 114, themselves, are designed with receptacles in such a way as to accommodate a detachable tertiary component, namely, a coupling hinge 122 for use during a beam bending test. The coupler 118, which may optionally be used for realignment, may help to allow for more even load redistribution during a double shear test. The coupling hinge 122 and the assembled pair of clamps 114 can be joined together to form a simple hinge held by a grooved coupling pin 124 and a pair of circlips 126. The gripping rod 120 with threaded end allows its mounting on to the coupler 118 and then to the structural block 110 using a grooved coupling pin 128 and a pair of circlips 130 to have a mechanism suitable for axially loaded test types (single and double shear tests and their variants).

In order to conduct a single-lap shear test of FIGS. 1A and 1B, the pair of clamps 114 needs to be used as supports for NSM FRP bar (as shown in FIGS. 7A and 7B). To achieve this, the gripping rod 120 is attached to either the structural block 110 directly or to the optional coupler 118 first, followed by attaching the gripping rod 120 and the coupler 118 to the structural block 110 using the coupling pin 128 and the pair of circlips 130. With the gripping rod 120 clamped using an upper jaw of a suitable servo hydraulic machine and the concrete block/specimen fixed, the protruding NSM FRP is clamped using the pair of clamps 114 and secured tight with the aid of a series of bolts 132. An axially applied load is then applied gradually via the debonding test apparatus 100 onto the protruding NSM FRP until its detachment/bond failure from the media. In order to simulate the effect of edge distance to the NSM groove for structural applications, the same configuration of the debonding test apparatus as that used in the single shear test is adopted. However, instead of placing the NSM FRP bar in the middle of the concrete block of the traditional single shear test, an offset distance that positions the bar in a non-symmetric fashion is adopted (FIGS. 1E and 1F). With this, the debonding test apparatus 100 is used to subject the protruding NSM bar to an axial pull-off loading as shown in FIGS. 7C and 7D until bond failure.

The debonding test apparatus 100 of the present disclosure also allows to test the bond using double shear test using only a single block (FIGS. 7E and 7F) contrary to the use of two blocks in the traditional version of the test shown in FIGS. 1C and 1D. To achieve this, the two FRP bars of the double shear test are embedded into only one concrete block, while the end of the FRP bars are allowed to protrude in a manner similar to that used in the single shear test. This substitution of one of the concrete blocks for testing the NSM bond under double shear is made possible by the debonding test apparatus 100. Hence, the debonding test apparatus 100 allows for more economical use of materials during such test types by reducing the specimen weight and size by half in addition to allowing easier handling of the specimens which minimizes the tendency of damaging the bond even prior to testing when heavy specimens are used. It may be noted that the use of NSM FRP bars for in situ strengthening of structural members is composed of several such bars arranged side by side close to each other (for example, at the bottom of flexural loaded members) in order to achieve a given strength/capacity enhancement of the retrofitted structure. The debonding test apparatus 100 is also convertible to adapt to the second version of the double shear test, namely, the non-symmetric double shear bond test of FIGS. 1G and 1H. FIGS. 7G and 7H illustrate the application of the debonding test apparatus 100 to achieve the same until the full debonding of the NSM FRP. With this, the interaction of the internal stress fields caused by more than one bar can be studied with the aid of the debonding test apparatus 100.

Furthermore, the beam bending test method of FIGS. 1I and 1J is made possible using the debonding test apparatus 100 by substituting half of the traditional beam specimen. Unlike the debonding test apparatus of U.S. Pat. No. 11,169,082B2 where EBR FRP bond testing using the beam test was designed to clamp the hanging FRP sheet using a steel plate with a set of bolts, the clamping system of NSM FRP is more challenging since bar bending could trigger its fracture prior to the bond failure. Hence, the pair of clamps 114 and the bolts 132 are used for that purpose. The half concrete specimen is first fabricated, and the groove made inside it is made to receive the NSM FRP bar glued using epoxy adhesive, leaving behind the protruding portion of the bar suitable for clamping using the debonding test apparatus 100. As shown in FIGS. 71 and 7J, the test is implemented with the concrete specimen installed horizontally and by flushing the edges of the debonding test apparatus 100 with the specimen while the FRP bar is sandwiched between the pair of clamps 114. The coupling hinge 122 is attached to the concrete block using a pair of bolts 134, while the coupling pin 124 and the pair of circlips 126 are used to link the half hinged concrete block with the debonding test apparatus 100 via the pair of clamps 114. With the debonding test apparatus 100 representing the missing half concrete specimen, the setup is tested as a beam under three-point loading until the NSM FRP-concrete bond failure. If needed, the side plate 116 can be used in the beam bending test to prevent the FRP bar from being forcefully ejected due to possible slippage during the loading.

With the substitution of half of the traditional test specimens for most of the test types, the debonding test apparatus 100 aims to provide enormous savings in material cost and efforts needed to fabricate different test apparatuses for different strengthening systems, as well as encourage consistency in testing across different laboratories if adopted, thereby avoiding subjective purpose-built test setups for different systems and for different test methods.

During any of the above variants of the NSM FRP-concrete bond test types, suitable data acquisition systems, such as strain gages, linear variable displacement transducers (LVDTs), digital image correlation (DIC), etc., can be used to provide local bond strength and bond-slip relationships useful for designing the NSM FRP strengthening prior to its deployment in the field.

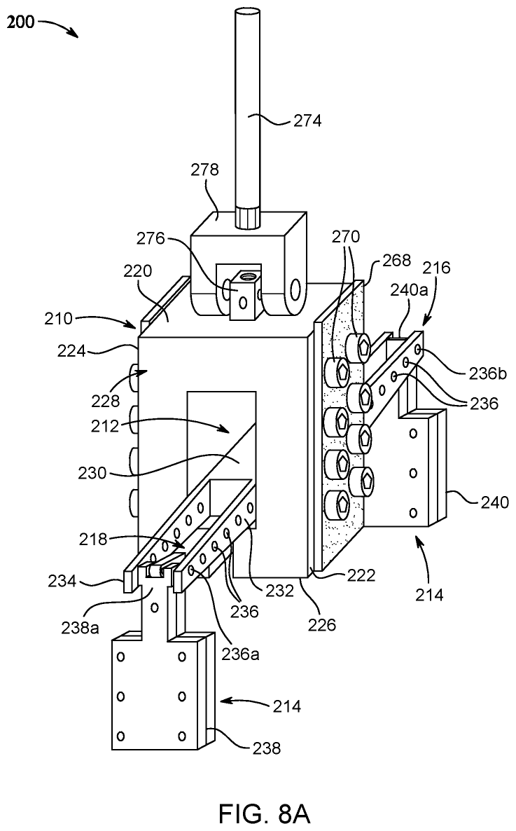

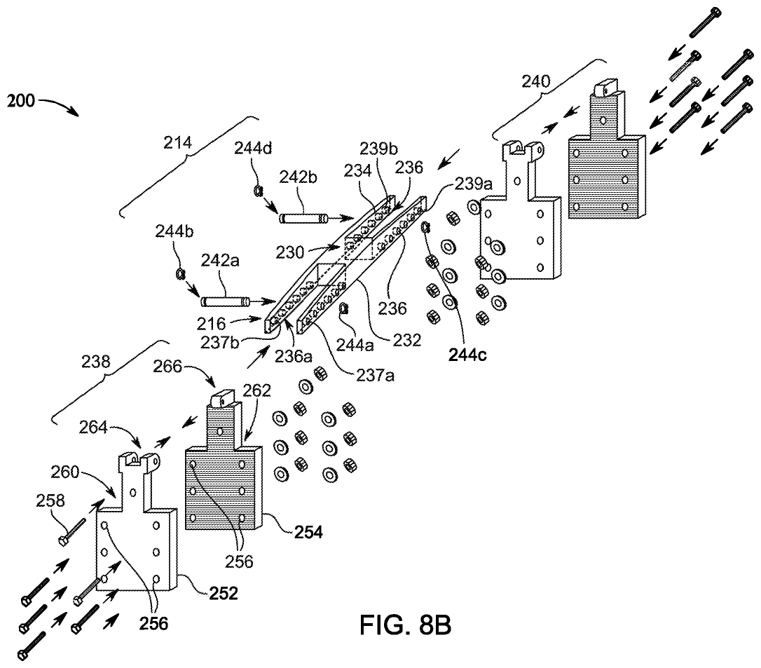

Referring to FIGS. 8A-8B, in combination, illustrated are different views of a debonding test apparatus (generally designated by reference numeral 200), according to a second embodiment of the present disclosure. The debonding test apparatus 200 includes a structural block 210 having a receiving space 212 formed therein, a pair of clamps 214, an adjustable hanger 216, and an attachment mechanism 218. The structural block 210 includes a top surface 220, a first lateral surface 222, a second lateral surface 224, a bottom surface 226, and a structural body 228. The structural body 228 extends from the top surface 220 to the bottom surface 226, spanning between the first lateral surface 222 and the second lateral surface 224. The receiving space 212 traverses through the structural body 228 between the first lateral surface 222 and the second lateral surface 224 adjacent to the bottom surface 226 of the structural block 210. The adjustable hanger 216 is slidably positioned into the receiving space 212 adjacent to its top end. The pair of clamps 214 is slidably coupled to the adjustable hanger 216. The structural block 210, the pair of clamps 214, and the adjustable hanger 216 are detachably attached to each other through the attachment mechanism 218.

The structural block 210 is a sturdy component that provides the foundational support for the debonding test apparatus 200. The structural block 210 is generally a three-dimensional rectangular solid, characterized by the structural body 228 that extends from the top surface 220 to the bottom surface 226, between the first and second lateral surfaces 222 and 224. This design offers stability and ensures that the debonding test apparatus 200 can bear the weight and stress of the materials being tested. The height, length, and width of the structural body 228 can vary from one embodiment to another. For example, in one embodiment a width, a length, and a height of the structural body 228 can be 120-millimeter (mm), 100 mm, and 170 mm respectively. It may be appreciated that the concrete prism used with the structural block 210 can have its same height, length, and width corresponding to the structural body 228. Even though specific dimensions were described in the example, a wide range of dimensions can be used with the components of the debonding test apparatus 200 since the concrete prism is not limited in size or shape.

Within the structural body 228 of the structural block 210, the receiving space 212 is formed adjacent to the bottom surface 226 and traverses through the structural body 228 between the first and second lateral surfaces 222 and 224. The positioning and orientation of the receiving space 212 provide the necessary channel for the adjustable hanger 216 to be slidably inserted and positioned adjacent to the top end of the receiving space 212 (as illustrated in FIG. 7A). The adjustable hanger 216 facilitates the attachment and positioning of the pair of clamps 214. The adjustable hanger 216 includes a middle block 230, a first arm portion 232, a second arm portion 234, and a plurality of receiving slots 236 formed therein. The middle block 230 is positioned between the first and second arm portions 232 and 234, serving as a central support structure. The receiving slots 236, which perpendicularly traverse through the first and second arm portions 232 and 234, are provided to allow for the sliding insertion of the pair of clamps 214. This positioning allows the adjustable hanger 216 to hang vertically downwards, with the first and second arm portions 232 and 234 extending on either side of the structural block 210.

The pair of clamps 214 holds the test material securely during the testing process. The pair of clamps 214 may be made of steel material or the like. The pair of clamps 214 includes a first clamp 238 and a second clamp 240. In one embodiment, the first clamp 238 of the pair of clamps 214 includes a first top portion 238a. The first top portion 238a is in the form of narrow extrusion in the first clamp 238. The first top portion 238a is hollow in design. The first top portion 238a is positioned between the first and second arm portions 232 and 234 of the adjustable hanger 216. The first top portion 238a is concentrically aligned with a first receiving slot 236a of the plurality of receiving slots 236. Similarly, the second clamp 240 of the pair of clamps 214 includes a second top portion 240a. The second top portion 240a is in the form of narrow extrusion in the second clamp 240. The second top portion 240a is hollow in design. The second top portion 240a is positioned between the first and second arm portions 232 and 234 of the adjustable hanger 216. The second top portion 240a is concentrically aligned with a second receiving slot 236b of the plurality of receiving slots 236.

To ensure the clamps 214 are securely attached to the adjustable hanger 216, the debonding test apparatus 200 can further include pins, including a first pin 242a and a second pin 242b. The first pin 242a is concentrically aligned with the first receiving slot 236a and is slidably positioned through a first portion 237a of the first receiving slot 236a which traverses the first arm portion 232, the first top portion 238a of the first clamp 238, and a second portion 237b of the first receiving slot 236a which traverses the second arm portion 234. This arrangement ensures that the first clamp 238 is securely and adjustably attached to the adjustable hanger 216. Similarly, the second pin 242b is concentrically aligned with the second receiving slot 236b and is slidably positioned through a first portion 239a of the second receiving slot 236b which traverses the first arm portion 232, the second top portion 240a of the second clamp 240, and a second portion 239b of the second receiving slot 236b which traverses the second arm portion 234. This arrangement ensures that the second clamp 240 is securely and adjustably attached to the adjustable hanger 216.

The plurality of receiving slots 236 on the adjustable hanger 216 offers versatility in the placement of the pair of clamps 214. By sliding the pair of clamps 214 into these receiving slots 236, the debonding test apparatus 200 can accommodate test materials of different sizes and dimensions. The concentric alignment of the hollow top portions of the clamps 214, such as the top portions 238a and 240a, with the receiving slots 236, ensures that the clamps 214 are securely attached to the adjustable hanger 216. The pin 242a and 242b, when slidably positioned through the respective receiving slots of the plurality of receiving slots 236 and the hollow top portions 238a and 240a, further secure the clamps 214 to the adjustable hanger 216.

For added security and to prevent unintentional dislodging of the pins, the debonding test apparatus 200 can include a plurality of circlips. These circlips are mechanical fasteners configured to secure the first pin 242a and the second pin 242b. In one embodiment, the plurality of circlips includes a first circlip 244a positioned at the first portion 239a of the first receiving slot 236a, a second circlip 244b positioned at the second portion 237b of the first receiving slot 236a, a third circlip 244c positioned at the first portion 239a of the second receiving slot 236b, and a fourth circlip 244d positioned at the second portion 239b of the second receiving slot 236b. The plurality of circlips 244a-244d acts as mechanical barriers, preventing the pins 242a and 242b from unintentionally sliding out of their positions. This ensures that during a test, the test material remains securely gripped, reducing any chances of errors or discrepancies in the results.

Also, as illustrated, the first clamp 238 includes a first clamp block 252, a second clamp block 254, a plurality of bolt slots 256, and a plurality of block-fastening bolts 258. These bolt slots 256 perpendicularly traverse through both the first clamp block 252 and the second clamp block 254. The block-fastening bolts 258 are configured to traverse through the plurality of bolt slots 256. The block-fastening bolts 258 may engage with fastening washers or nuts. Thereby, the block-fastening bolts 258 are configured to fasten the first clamp block 252 and the second clamp block 254 together, to form the first clamp 238. In some examples, mating surfaces of the first clamp block 252 and the second clamp block 254 may be provided with texture (such as, ribs) to aid in the joining together thereof.

Further, as illustrated, the first clamp block 252 includes a first T-shaped portion 260, and the second clamp block 254 includes a second T-shaped portion 262. When fastened, these T-shaped portions 260 and 262 align. Also, the first clamp block 252 includes a first top section 264 above the first T-shaped portion 260, and the second clamp block 254 includes a second top section 266 above the second T-shaped portion 262. That is, above these T-shaped portions 260 and 262, the first and second clamp blocks 252 and 254 respectively have the first top section 264 and the second top section 266. As may be seen, a pin slot (not labelled) traverses through the first top section 264 and the second top section 266, forming the first top portion 238a (as previously mentioned) of the first clamp 238. This first top portion 238a of the first clamp 238 is hollow.

It may be appreciated, as also may be seen from FIG. 8B, that the second clamp 240 may also have similar configuration to the first clamp 238, with similar two blocks with T-shaped portions, etc., and thus these details for the second clamp 240 have not been described herein for brevity of the present disclosure.

In the present configuration, the arrangement of the adjustable hanger 216 is such that the middle block 230 is positioned between the first receiving slot 236a and the second receiving slot 236b. Further, the first receiving slot 236a and the second receiving slot 236b can have an equal distance from the middle block 230. That is, both the first receiving slot 236a and the second receiving slot 236b can be equidistant from the middle block 230, ensuring symmetry and balance in design of the debonding test apparatus 200.

In some embodiments, as illustrated, the debonding test apparatus 200 further includes an attachment plate 268 to enhance the versatility and adaptability thereof. The attachment plate 268 is characterized by a plurality of bolt slots (not visible). The debonding test apparatus 200 also includes a plurality of plate-fastening bolts 270 designed to traverse through these bolt slots. This allows the attachment plate 268 to be fastened securely to the first lateral surface 222 of the structural block 210. The attachment plate 268 can be fastened to the first lateral surface 222 of the structural block 210 during testing.

In some embodiments, as illustrated, the debonding test apparatus 200 further includes a threaded gripping rod 274 for added functionality. The gripping rod 274 is designed to be threadedly engaged with a receiving channel 276 that traverses through the top surface 220 of the structural block 210. To ensure proper alignment and functionality, a realignment coupler 278 is positioned between the top surface 220 of the structural block 210 and the threaded gripping rod 274 when the threaded gripping rod 274 is engaged.

In a typical testing scenario, the test material can be anchored to the debonding test apparatus 200 using the attachment plate 268. In other scenarios, the adjustable hanger 216 is then slidably inserted into the receiving space 212 of the structural block 210. Depending on the size and dimensions of the test material, the pair of clamps 214 are slidably attached to the appropriate receiving slots 236 on the adjustable hanger 216. The test material (FRP) is then placed between the clamps 214, ensuring it is gripped securely by the T-shaped portions 260 and 262 therein. Once the setup is complete, force or pressure is applied, using the threaded gripping rod 274, to assess the adhesive bond strength of the test material.

The debonding test apparatus 200 of the present disclosure may have some alternate configurations. For instance, while the structural block 210 has been described as a three-dimensional rectangular solid, it can be redesigned in different shapes, such as cylindrical, triangular prism, or any other geometric form, based on specific testing needs or to accommodate different test environments. Further, the receiving space 212 can be designed to be adjustable in width, allowing for the insertion of different sizes of adjustable hangers or to accommodate additional components. Instead of a pair of clamps 214, the debonding test apparatus 200 can be equipped with multiple clamps, allowing for simultaneous testing of several test materials. These clamps 214 can be of varying sizes and designs to hold materials with diverse geometries. Further, while the attachment mechanism 218 relies on pins and circlips, alternate embodiments can employ magnetic attachments, vacuum-based systems, or even advanced locking mechanisms for quicker and more secure attachments.

In further embodiments of the present disclosure, the first clamp 238 and/or the second clamp 240 from the pair of clamps 214 may be provided with more detailed features (not shown). In some exemplary embodiments, the first clamp 238 may be provided with a top section, a middle section below the top section, and a bottom section below the middle section. The design of the middle section in conjunction with the top section forms a first T shape. Similarly, the combination of the middle section and the bottom section forms a second T shape. Notably, this second T shape is oriented upside down relative to the first T shape, ensuring a versatile gripping mechanism.

It may be appreciated by a person skilled in the art that the additional modifications made to the debonding test apparatus 200 of FIGS. 8A-8B (as per the second embodiment of the present disclosure), as compared to the debonding test apparatus 100 of FIGS. 6A-6C (as per the first embodiment of the present disclosure), allows it to be used to test both wet layup FRP sheets, pultruded FRP laminates, NSM FRP, FRCM, etc. Due to these universal features, the debonding test apparatus 200 may be used as a single device for all strengthening schemes and for all test methods.

Specifically, in the debonding test apparatus 200, the pair of rollers (rotatable hollow cylinders) 26, 36 or 46 (shown in FIGS. 2A-2B, 3A-3B and 4) can be partially or wholly substituted with the pair of clamps 214 (as shown in FIGS. 8A and 8B) which are more robust and stronger. When coupled, the adjustable hanger 216 and the structural body 228, and the pair of clamps 214 form part of the debonding test apparatus 200. With this, the need for U-shape/wrapped composite FRP 22, 32 or 42 of the traditional setup is eliminated for testing purposes.

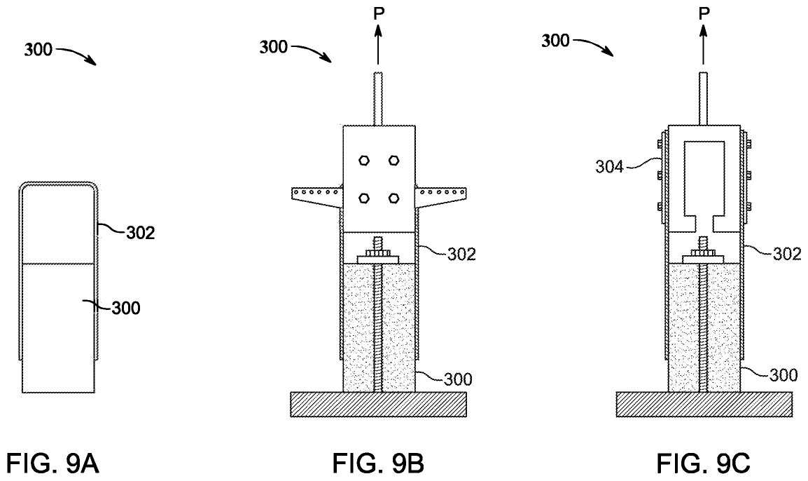

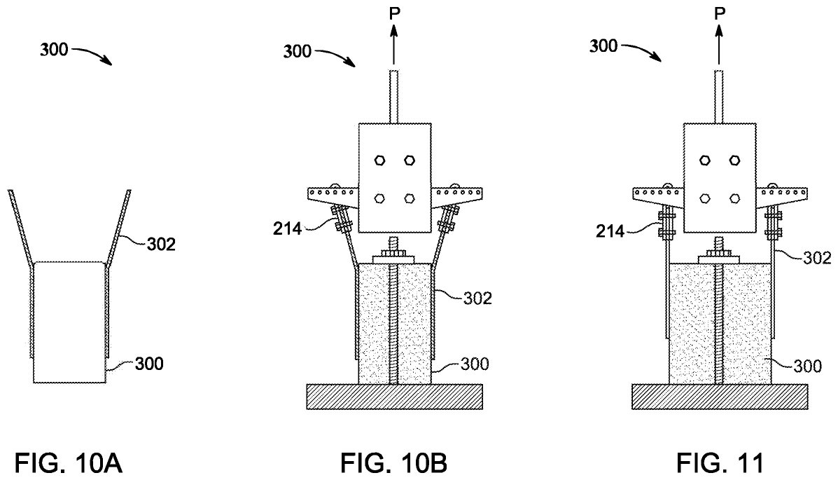

Further referring to FIGS. 9A-9C, 10A-10B and 11, illustrated are extensions in design of the debonding test apparatus 200 to unbendable pultruded FRP laminates for different test methods by subjecting to a loading force ‘P’, according to certain embodiments. As shown, foldable dry fibers in the wet layup system or unbendable pultruded laminates can be attached as two straight disconnected sheets 302 on opposite sides of a concrete specimen 300 to allow each of the pair of clamps 214 (or a pair of side plates 304) in the debonding test apparatus 200 to be used to grip the two straight FRP/composite strips during the double shear-lap test (as depicted in FIGS. 9A-9C), the mixed-mode test (as depicted in FIGS. 10A-10B), or the variable specimen size double-lap shear test (as depicted in FIG. 11). Moreover, even in the case of a wet layup system, the use of the pair of clamps 214 eliminates the tendency of fiber rupture by allowing the casting of the test specimen with disconnected FRP sheets rather than the U-shape dry fibers that suffer from the tendency of rupture due to stress concentration. Such design configurations enable the debonding test apparatus 200 to adapt to other forms of strengthening systems, such as the unbendable composites.

The debonding test apparatus (e.g. 100, 200 and the like) of the present disclosure offers several advantages over known prior art. The debonding test apparatus herein provides a comprehensive, accurate, and efficient means to test adhesive bond strength between materials. The modular and adjustable design of the debonding test apparatus allows for testing a variety of materials of different sizes and shapes. The design of the pair of clamps 114 or 214, especially with the T-shaped portions, provides a versatile gripping mechanism suitable for a variety of test materials. The debonding test apparatus is robust, durable, and designed for repeated use, making it a cost-effective solution for industries looking to assess adhesive bond strength consistently.

Furthermore, the inclusion of the adjustable hanger 216 in the debonding test apparatus 200 with multiple receiving slots 236 ensures that the pair of clamps 214 can be positioned at various heights, accommodating different test scenarios. Additionally, the secure fastening mechanisms, including the circlips 244a-244d and the block-fastening bolts 258, ensure that the test material is held securely during the testing process, reducing the chances of errors or inaccuracies.

Numerous modifications and variations of the present disclosure are possible in light of the above teachings. It is therefore to be understood that within the scope of the appended claims, the invention may be practiced otherwise than as specifically described herein.

1. A debonding test apparatus, comprising:
a structural block having a receiving space formed therein;
a pair of clamps;
an adjustable hanger; and
an attachment mechanism, wherein
the structural block comprises a top surface, a first lateral surface, a second lateral surface, a bottom surface, and a structural body,
the structural body extends from the top surface to the bottom surface between the first lateral surface and the second lateral surface,
the receiving space traverses through the structural body of the structural block between the first lateral surface and the second lateral surface adjacent the bottom surface of the structural block,
the adjustable hanger is slidably positioned into the receiving space adjacent a top end of the receiving space,
the pair of clamps is slidably coupled to the adjustable hanger, and
the structural block, the pair of clamps, and the adjustable hanger are detachably attached to each other through the attachment mechanism.

2. The debonding test apparatus of claim 1, wherein:
the adjustable hanger comprises a middle block, a first arm portion, a second arm portion, and a plurality of receiving slots formed in the adjustable hanger,
the middle block is positioned between the first arm portion and the second arm portion, and
the plurality of receiving slots perpendicularly traverses through the first arm portion and the second arm portion.

3. The debonding test apparatus of claim 2, wherein:
the pair of clamps includes a first clamp having a first top portion that is positioned between the first arm portion and the second arm portion,
the first top portion is concentrically aligned with a first receiving slot of the plurality of receiving slots, and
the first top portion is hollow.

4. The debonding test apparatus of claim 3, further comprising a first pin, wherein:
the first pin is concentrically aligned with the first receiving slot, and
the first pin is slidably positioned through a first portion of the first receiving slot traversing the first arm portion, the first top portion of the first clamp, and a second portion of the first receiving slot traversing the second arm portion.

5. The debonding test apparatus of claim 4, wherein:
the pair of clamps includes a second clamp having a second top portion that is positioned between the first arm portion and the second arm portion,
the second top portion is concentrically aligned with a second receiving slot of the plurality of receiving slots, and
the second top portion is hollow.

6. The debonding test apparatus of claim 5, further comprising a second pin, wherein:
the second pin is concentrically aligned with the second receiving slot, and
the second pin is slidably positioned through a first portion of the second receiving slot traversing the first arm portion, the second top portion of the second clamp, and a second portion of the second receiving slot traversing the second arm portion.

7. The debonding test apparatus of claim 6, further comprising a plurality of circlips configured to mechanically secure the first pin and the second pin.

8. The debonding test apparatus of claim 7, wherein the plurality of circlips comprises:
a first circlip positioned at the first portion of the first receiving slot;
a second circlip positioned at the second portion of the first receiving slot;
a third circlip positioned at the first portion of the second receiving slot; and
a fourth circlip positioned at the second portion of the second receiving slot.

9. The debonding test apparatus of claim 4, wherein the pair of clamps comprises a first clamp including:
a first clamp block;
a second clamp block;
a plurality of bolt slots that perpendicularly traverse through the first clamp block and the second clamp block; and
a plurality of block-fastening bolts that traverse through the plurality of bolt slots, are engageable with fastening washers or nuts, and are configured to fasten the first clamp block and the second clamp block.

10. The debonding test apparatus of claim 9, wherein:
the first clamp block includes a first T-shaped portion, and
the second clamp block includes a second T-shaped portion that is aligned with the first T-shaped portion when fastened.

11. The debonding test apparatus of claim 10, wherein:
the first clamp block includes a first top section above the first T-shaped portion,
the second clamp block includes a second top section above the second T-shaped portion, and
a pin slot traverses through the first top section and the second top section, which forms the first top portion of the first clamp which is hollow.

12. The debonding test apparatus of claim 5, wherein:
the middle block is positioned between the first receiving slot and the second receiving slot.

13. The debonding test apparatus of claim 12, wherein:
the first receiving slot and the second receiving slot have an equal distance from the middle block.

14. The debonding test apparatus of claim 1, further comprising:
an attachment plate having a plurality of bolt slots; and
a plurality of plate-fastening bolts that traverse through the plurality of bolt slots and are configured to fasten the attachment plate to the first lateral surface of the structural block.

15. The debonding test apparatus of claim 1, further comprising:
a threaded gripping rod threadedly engageable with a receiving channel traversing through the top surface of the structural block.

16. The debonding test apparatus of claim 15, further comprising:
a realignment coupler between the top surface of the structural block and the threaded gripping rod when the threaded gripping rod is engaged.

17. The debonding test apparatus of claim 1, further comprising:
a coupling hinge having grooves and engageable with one of the pair of clamps via a groove pin.

18. The debonding test apparatus of claim 17, further comprising:
a pair of bolts configured to attach the coupling hinge to a concrete block.

19. The debonding test apparatus of claim 1, wherein:
the pair of clamps includes a first clamp having a top section, a middle section below the top section and a bottom section below the middle section,
the middle section and the top section form a first T shape, and
the middle section and the bottom section form a second T shape.

20. The debonding test apparatus of claim 19, wherein:
the second T shape is oriented upside down relative to the first T shape.
